(19) United States
(12) Patent Application Publication
(10) Pub. No.: US 2004/0245247 A1
(43) Pub. Date: Dec. 9, 2004

(54) Cooling system for ovens

(76) Inventor: Mahesh B. Rawal, San Bernardino, CA (US)

Correspondence Address: Greenberg and Lieberman, 314 Philadelphia Avenue, Takoma Park, MD, 20912, US

(21) Appl. No.: 10/690,464

(22) Filed: Oct. 20, 2003

Related U.S. Application Data
(60) Provisional application No. 60/319,626, filed on Oct. 18, 2002.

(51) Int. Cl. A21B 1/22; H05B 6/64

(52) U.S. Cl. 219/757; 219/400

(57) ABSTRACT

A cooling system for microwave and/or convection ovens that allows air to ventilate into the interior of the oven to cool food. Adaptations allow the air to traverse across the interior of the oven along different paths, and a refrigeration system can assist in providing cooler air than ambient room temperature.

Priority is hereby claimed to U.S. Patent Application Ser. No. 60/319,626 filed on Oct. 18, 2002.

### FIELD OF THE INVENTION

The present invention is a cooling system for ovens. More specifically, the present invention is a system for cooling food in an oven so that the food is not undesirably hot for the user.

### BACKGROUND OF THE INVENTION

Microwave cooking has become a regular activity in nearly every American household. Not only are foods designed for microwave cooking, such that they are sold in microwave safe containers, but certain foods are sold only with instructions for microwave cooking. Without question, the microwave cooking has become popular because it is a quick and easy way to cook food.

However, microwave cooking does not come without its disadvantages. One of the most common complaints associated with microwave cooking is the propensity of microwave ovens to heat food unevenly. A plate of food cooked in a microwave oven rarely heats properly. After microwave cooking, food toward the perimeter of the plate is oftentimes much hotter than food toward the center of the plate.

Several common methods attempt to ensure that food is heated adequately in a microwave. One typical approach to microwave cooking rotates the plate of food in the microwave to provide more even exposure of the food to microwave radiation; however, rotating a plate does not affect the food at the plate's center, which remains at a lower temperature than the food around the plate's perimeter. A second approach involves spreading food around the perimeter of a plate; however, it is rather impractical to avoid using the center of the plate for cooking. Moreover, a variety of microwave-ready dinners are prepackaged and frozen, so rearranging the food is impossible. Another approach to microwave cooking is to overheat the food along the perimeter of the plate so that the food in the center of the plate is adequately hot; however, the user can easily burn the user's tongue and mouth because the parts of the food at the plate's edge have been considerably overheated.

Even conventional convection ovens oftentimes render food much too hot for eating once cooking has ceased. While food can be placed on a burner to cool for a few minutes, removing hot food is always a hazard. Furthermore, the propensity to underestimate whether food has cooled long enough for consumption is a constant annoyance.

U.K. Patent application no. GB2,321,835 issued to Andrews on Jan. 30, 1997 shows a microwave oven with removable door assembly. Andrews' invention is unlike the present invention because it does not provide a means for evenly heating food in a microwave, or cooling food in a microwave after cooking.

U.S. Design Pat. No. D393,179 issued to Baldwin on Apr. 7, 1998 shows a front panel of a microwave. Baldwin's invention is unlike the present invention because it does not provide a means of evenly heating food in a microwave, and it does not provide a means to cool food in a microwave before consumption.

U.K. Patent application no. GB2,342,438 issued to Kim, et al., on Jul. 10, 1998 shows a front panel assembly for a microwave oven. Kim's invention is unlike the present invention because it does not have a means of evenly heating food in a microwave, or a means of cooling food in a microwave.

U.S. Pat. No. 6,140,627 issued to Jeon on Oct. 31, 2000 shows a control panel assembly of a microwave oven. Jeon's invention is unlike the present invention because it does not provide a means to evenly heat food in a microwave, or a means to cool food in the microwave after cooking.

U.S. Pat. No. 6,420,690 issued to Kim on Jul. 16, 2002 shows a microwave oven having a vent grill formed as part of a door and/or control panel. Kim's invention is unlike the present invention because it does not provide a means for evenly heating food, or a means for cooling food in a microwave, but instead is merely a repositioning of the existing ventilation systems in microwave ovens.

U.S. Design Pat. No. D461,365 issued Hessen, et al., on Aug. 13, 2002 shows an external surface configuration for the front panel of an over the range microwave oven. Hessen's invention is unlike the present invention because it does not provide a method of evenly heating food in a microwave and it does not provide a method of cooling food in the microwave.

European Patent no. EP0856703 issued to Uehashi, et al., on Aug. 28, 2002 shows a cooking device. Uehashi's invention is unlike the present invention because it uses infrared sensors to test the temperature of the food cooked, but does not provide a means for evenly heating food in a microwave or cooling food in a microwave after cooking.

PCT no. WO 02/067631 issued to Donahue published on Aug. 29, 2002 shows a microwave activated deodorizer for microwave oven. Donahue's invention is unlike the present invention because it does have a method of evenly heating food in the microwave and does not have a method of cooling the food in the microwave.

Therefore, a need has been established for a method of cooling food along the perimeter of a plate before, during, or after the food has been cooked in a microwave. Additionally, there is a need for a simple solution to maintain the desired warmth of food in the plate's center while food along the plate's perimeter is being cooled. Furthermore, there is a need for a quick solution to removing excess heat from food so that the user does not encumber the process of microwave cooking to such a degree that the very concept of microwave cooking has become overly burdensome. Moreover, there is a need for having any cooling effect variable depending upon the user's preference so that food does not become too cold or remain too hot. Also, there is a need to cool food prepared in convection ovens so that users are not burned removing food from the oven. Even more, there is a need to adequately cool food retrieved from convention ovens so that the user is not burned upon consuming the food right after its removal from the oven.

### SUMMARY OF THE INVENTION

A new feature or function on a microwave oven or even a standard convection oven control panel that would appear, in one embodiment, as “COOL/WARM,” which controls the ability of a microwave oven or standard convention oven to warm or cool an item for a desired period of seconds or minutes instead of making it hot. Any overheated item is heated correctly and is available for an immediate serving. The present invention ideally returns an overheated item to a normal heated level, but can also compensate for overheating by affecting food before and during heating. In other embodiments, cooling and warming functions are separate. In other embodiments, control over a fan is enabled for exhausting and/or introducing air into an oven. The present invention can also serve as a separate unit with such features, so that the user places food in the separate unit prior to or subsequent to cooking.

The present invention is a cooling system for microwave ovens or convection ovens. The present invention cools the inside of an oven via circulating air from outside the oven into the oven's interior and/or providing refrigeration. Fresh air can be introduced along the sides and corners of the oven's interior, such that a convection of air traverses the hottest areas of food to avoid cooling the cooler center of a plate of food that has been cooked in a microwave oven. Refrigeration techniques can be employed to “super cool” the air introduced along the sides and corners of the oven. Various placements of air vents can set up various convention currents to cool the food as well. Refrigeration can also occur so that the interior walls of the oven become cold themselves, essentially drawing excess heat from the food.

### BRIEF DESCRIPTION OF THE DRAWING(S)

FIG. 1 is an exploded view showing first holes and a removable wall of the present invention.

FIG. 2 is an exploded view showing a section that is biased of the present invention.

FIG. 3 is an exploded view of an insert that is used in conjunction with second holes in a first embodiment of the present invention.

FIG. 4 is an exploded view of an insert that is used in conjunction with second holes in a second embodiment of the present invention.

FIG. 5 is an exploded view of a microwave and heat safe cover in conjunction with the oven of the present invention.

FIG. 6 is an exploded view of a blower in conjunction with the oven of the present invention.

### DETAILED DESCRIPTION OF THE PREFERRED EMBODIMENT(S)

Aiming to cool food before, during, and/or after oven cooking (whether convection or microwave), the present invention employees air currents and/or refrigeration to achieve its goal.

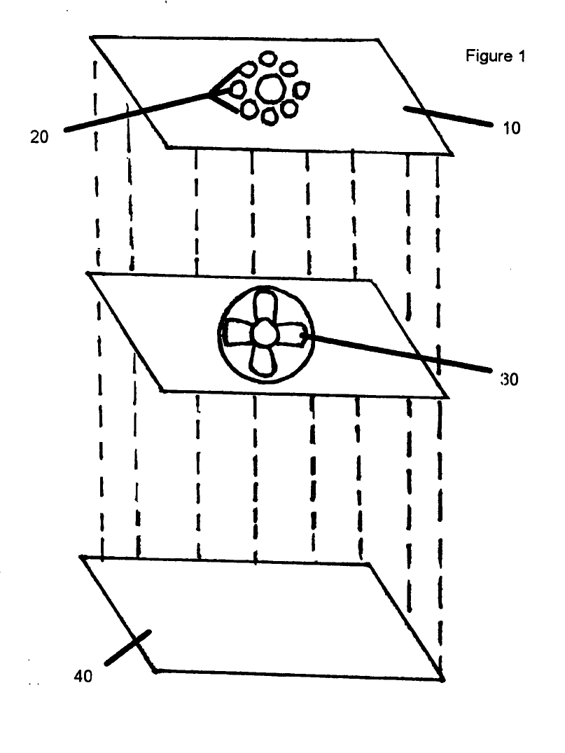

FIG. 1 is an exploded view showing the top of an oven (10) with first holes (20) so that a fan (30) can ventilate air from to and from oven (10). A removable wall (40) of oven (10) can either be manually or mechanically biased so that fan (30) can function by allowing air to move through holes first (20). In this embodiment of the present invention, wall (40) would function as a microwave energy insulator if oven (10) were a microwave oven, protecting users from dangerous microwave radiation. Similarly, wall (40) would function as a convection oven insulator if oven (10) were a convection oven, keeping hot air in oven (10).

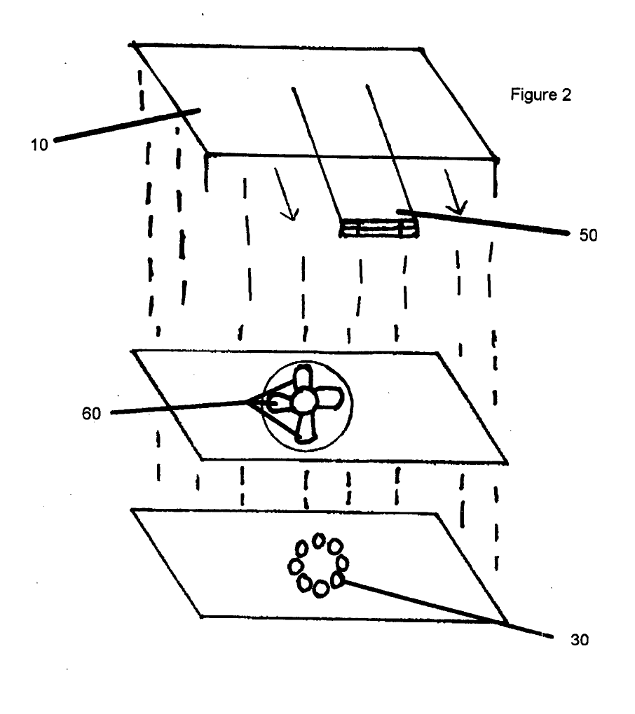

Wall (40) is replaced by section (50) in FIG. 2, such that section (50) is merely a portion of oven (10) that can be manually or mechanically biased. Section (50) functions identically to wall (40) so that air can pass into and out of oven (10), or is obstructed from doing so. It is contemplated that section (50) can be of varying design so that, in some embodiments, section (50) is pulled and pushed in and out of oven (10) via conventional means of attachment. In other embodiments, section (50) is twisted and/or hooked into and out of oven (10) via conventional means of attachment. Section (50) can, in further embodiments, communicate electrically and/or manually with fan (30) so that when section (50) exposes the inside of oven (10) to air, fan (30) is automatically energized—this can be wired via conventional means.

Of particular note is that section (50) can be ideally placed in the ceiling of oven (10) or the floor of oven (10)—or even on the back wall of the oven (10). If section (50) is in the ceiling of oven (10), air flows into oven (10) and drops down upon food in oven (10). If section (50) is in the floor of oven (10), air flows into oven (10) and cools any plate of food in oven (10) from underneath the plate at first. If section (50) is in the back wall of oven (10), then airflows into oven (10) and cools any plate of food in oven (10) by passing air over and across the food. Ideally, a plethora of second holes (60) are positioned in a circular pattern to direct air along the perimeter of any food in oven (10). Since edges of food tend to overcook, whether a microwave oven or convection oven is employed, a circular pattern of second holes (60) encourages movement of cooling air to the outer edges of food first. Thus, the desired warmth of the interior region of food is maintained during the cooling process while undesirable overheated edges of food are targeted for cooling.

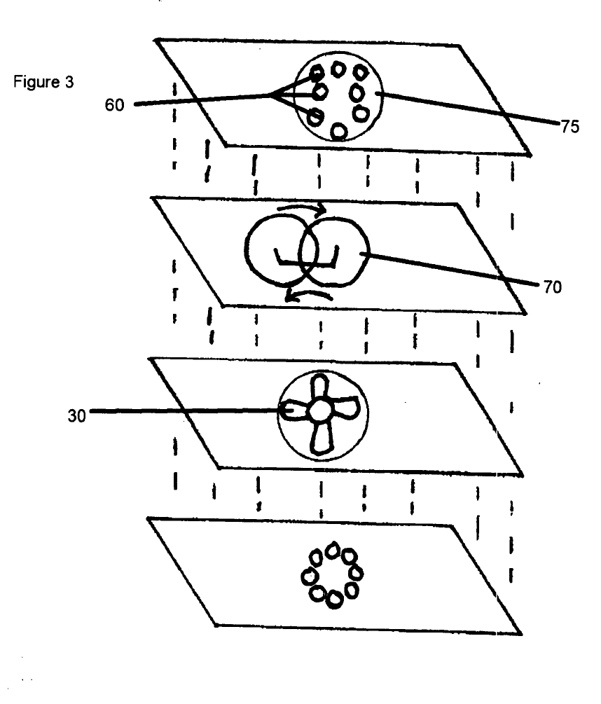

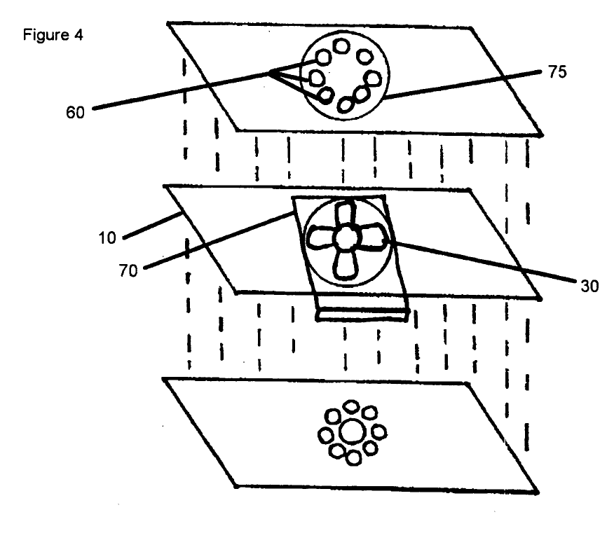

FIGS. 3 and 4 show a specially configured insert (70) that is used in conjunction with second holes (60) and fan (30). In FIG. 3, insert (70) can slide or move to reveal fan (30) via any conventional means. Once fan (30) is not being used, insert (70) can be slid or rotated to cover fan (30). Plate (75) has second holes (60) that permit desired degrees of airflow to occur when fan (30) is operated. In FIG. 4, insert (70) slides within the ceiling, floor, or a side of oven (10). As in FIG. 3, FIG. 4 shows plate (75) having second holes (60) that permit desired degrees of airflow to occur when fan (30) is operated. In general, the second holes (60) are preferably in a circular pattern to force air to hit the perimeter of food in oven (10).

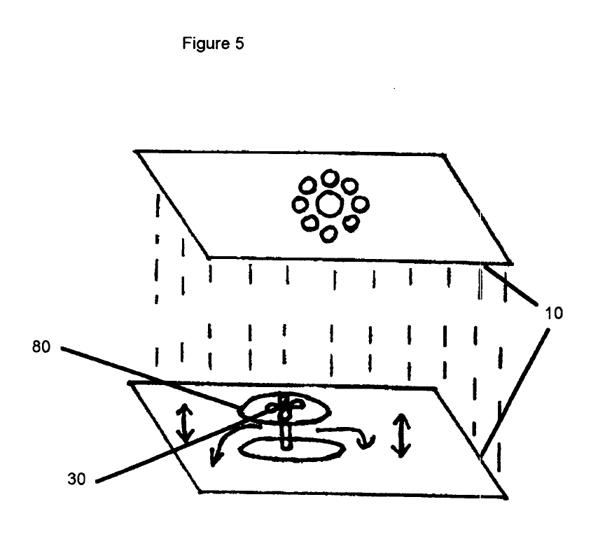

FIG. 5 shows microwave and heat safe cover (80) which covers fan (30) so that air is directed around the sides of oven (10) as opposed to directly in line with fan (30). Cover (80) can be integrated as part of fan (30) or can merely be attachable to fan (30) should the user decide that directing air around sides of oven (10) is desirable. Cover (80) allows air to be channeled to the hottest parts of food if fan (30) is located above or below food in oven (10) because air flows over the perimeter of food.

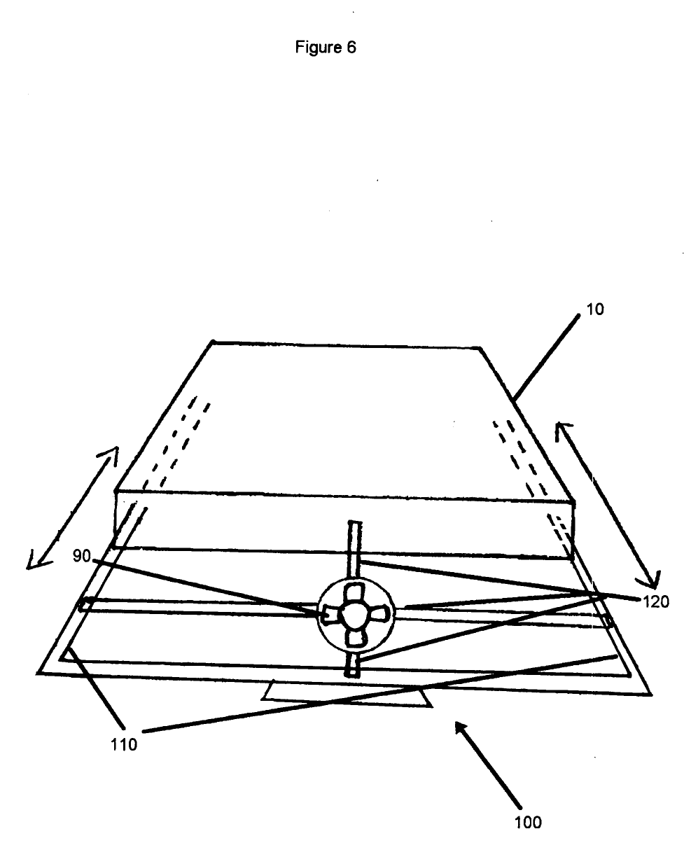

FIG. 6 shows blower (90) that is a moveable fan so that it can be inserted into the oven (10) when desired, and at various positions near food in oven (10). Should different food be cooked in oven (10), blower (90) can be inserted and moved in oven (10) so that blower (90) passes airflow on the food which has heated faster than the rest of the food. Blower (90) is preferably supported by sliding and mounting apparatus (100) which can slide into and out of oven (10). Mounting apparatus (100) is generally two parallel bars (110) which support blower (90) mounted there between. Secondary bars (120) form a conventional substructure for blower (90), and secondary bars (120) hold blower (90) between bars (110). Blower (90) can be positioned on any side of oven (10), including the top and bottom of oven (10), and mounting apparatus (100), bars (110), and secondary bars (120) could similarly exist on any and all sides of oven (10), including the top and bottom of oven (10). Blower (90) can be integrated with oven (10) so that it is powered via oven (10), or optionally, blower (90) can be powered remotely.

The present invention, in the preferred embodiment, has four settings or buttons so that the user chooses one of the following options: cool fan, fan, exhaust fan, or warm fan. A cool fan option provides refrigeration from a conventional compressor with a blowing fan (30); while the fan option provides a blowing fan (30) only; while the exhaust fan option provides for air to be ventilated out of the interior of oven (10), rather than into the interior of oven (10); while the warm fan option provides for warm air to be blown with fan (30) via conventional heating elements located in oven (10), so that air warmer than room temperature can be introduced to food in oven (10). Oven (10) does not need to be closed in order for fan (30) to operate, and the desired time for fan (30) to operate can be regulated via a conventional keypad-timing device found in many convection and microwave ovens. It should be understood that the warming, cooling, and/or ventilation can occur before, during, and/or after conventional convection and/or microwave cooking.

In all embodiments of the present invention, a conventional refrigeration apparatus having a conventional compressor can be routed near fan (30) and/or blower (90) to assist in providing cool air into oven (10). In all embodiments of the present invention, a conventional heating apparatus having a conventional heating element can be routed near fan (30) and/or blower (90) to assist in providing warm air into oven (10). Further, a conventional compressor and/or a conventional heating apparatus can be present in any of the embodiments of the present invention without the need for fan (30) and/or blower (90).

The present invention can work to provide or remove air to food inside oven (10) before, during, and/or after heating of food. If oven (10) employs microwaves, then conventional radiation shields must be introduced so that fan (30) and/or blower (90) can operate without allowing radiation to leak outside oven (10). Conventional controls on oven (10) allow for the user to determine when air is provided and/or exhausted from oven (10), that is, before, during, and/or after cooking.

In another embodiment of the present invention, oven (10) is divided into two chambers, wherein food is heated via convection and/or microwave means in a first chamber, and then the food is removed from the first chamber. Next, the food is placed in the second chamber, wherein warming and/or cooling action is delivered, via any of the aforementioned means, to the food. Optionally, any divider piece between the two chambers can be removed and/or recessed into the top, bottom, or side of oven (10), and thus, the present invention would be nearly identical or identical to the aforementioned embodiments, in that there is one chamber which heats and cools food placed therein.

Lastly, it is contemplated that a cooling, warming, and/or ventilating device could be developed entirely separately from an oven. In such an embodiment, all features aforementioned would be available, but for simultaneous cooking. In such an embodiment, the user would place food in the separate device before and/or after cooking, but the advantage would be that the device could be an aftermarket addition to a kitchen that would not need incorporation into an oven. Alternatively, the present invention could be simply a plate or similar piece that sits in proximity to the food, such that heating, cooling, and/or movement of air all occur from the plate or similar piece. In one embodiment, the plate could include a built in fan, compressor, and/or heating elements, via conventional technology. Clearly, the plate could be employed inside or outside oven (10).

It should be understood that any holes and/or sliding mechanisms to enable airflow in the present invention can be any conventional means for permitting and restricting airflow. For example, a series of shutters can open and close as opposed to insert (70), for they accomplish the same purpose. Of course, the series of shutters can be automated on manually biased.

The present invention is not limited to the sole embodiments described above, but is encompassed within the following claims.

I claim:

1. A device for cooling food inside convection and microwave ovens, comprising:
a fan;
an oven, in communication with said fan; and
air holes in said oven, allowing air to flow from said fan into the interior of said oven.

2. A device for cooling food inside convection and microwave ovens, comprising:
a cooling system;
an oven, in communication with said cooling system; and
air holes in said oven, allowing air to flow from said cooling system into the interior of said oven.

3. A method for preparing food, comprising:
heating the food evenly;
cooling the food to an edible temperature; and
providing ventilation for an oven or other cooking device.

4. A method as in claim 3, wherein the food is placed on a plate during cooking, and said plate cools the food along the exterior rim of the plate during cooking.

5. A method as in claim 4, wherein said plate regulates overcooking of the food on the exterior rim of the plate by cooling the food on the exterior rim during and after cooking.

6. A method as in claim 3, wherein a fan is placed under the mid section of an oven or other cooking device, and said fan cools food in said oven from the bottom of said oven and along the exterior rim of any container of food, by a means of a circular configuration of vents.

7. A method as in claim 3, wherein an oven cools food after cooking, by a means of a ventilation, or cooling fan installed in said oven.

8. The device of claim 1, wherein said oven is a microwave oven.

9. The device of claim 1, further comprising a timer controlling when air flows through said air holes.

10. The device of claim 1, further comprising a movable panel in communication with said oven.

11. The device of claim 10, wherein said movable panel obstructs said air holes when air flow through said air holes is not desired.

12. The device of claim 2, wherein said cooling system is a compressor.

13. The device of claim 2, further comprising a timer controlling when said cooling system operates.

14. The device of claim 12, further comprising a timer controlling when said compressor operates.

15. The device of claim 1, wherein said oven has two chambers.

16. The device of claim 2, wherein said oven has two chambers.

17. The device of claim 3, further comprising the step of heating the food in a first chamber of an oven and then cooling the food in a second chamber of the oven.

18. The device of claim 15, wherein said two chambers are separated from one another via a movable partition.

19. The device of claim 16, wherein said two chambers are separated from one another via a movable partition.

20. The device of claim 17, wherein a movable partition divides a first chamber of the oven from the second chamber of oven.
